(19) United States
(12) Patent Application Publication
(10) Pub. No.: US 2023/0416119 A1
(43) Pub. Date: Dec. 28, 2023

(54) FILTER ASSEMBLY FOR DISINFECTING PATHOGENS USING ULTRAVIOLET LIGHT EMITTING DIODES (UV-LEDS) AND METHOD THEREFOR

(71) Applicant: U.S. ENVIRONMENTAL PROTECTION AGENCY, Washington, DC (US)

(72) Inventors: HODON RYU, CINCINNATI, OH (US); YOONTAEK OH, CINCINNATI, OH (US)

(21) Appl. No.: 18/242,125

(22) Filed: Sep. 5, 2023

Related U.S. Application Data
(63) Continuation-in-part of application No. 17/386,228, filed on Jul. 27, 2021, now Pat. No. 11,787,706.

(51) Int. Cl. C02F 1/32; C02F 1/00

(52) U.S. Cl. CPC C02F 1/325; C02F 1/003; C02F 2201/3222; C02F 2201/3228; C02F 2209/40; C02F 2307/06

(57) ABSTRACT

A Point of Use (POU) filtration device has a hollow conduit having open ends. An Ultraviolet Light Emitting Diode (UV-LED) module is coupled to the hollow container. The UV-LED module illuminating UV light into an interior of the hollow conduit, the UV light reflecting down the interior of the hollow conduit

### RELATED APPLICATIONS

This patent application is a Continuation-In-Part (CIP) of U.S. patent application Ser. No. 17/386,228, filed Jul. 27, 2021, entitled “Filter Assembly For Disinfecting Pathogens Using Multiple Wavelength Ultraviolet Light Emitting Diodes (UV-LEDs) and Method Therefor” which was a Divisional of U.S. Pat. No. 11,104,591, filed Jul. 24, 2019, entitled “Filter Assembly For Disinfecting Pathogens Using Multiple Wavelength Ultraviolet Light Emitting Diodes (UV-LEDs) and Method Therefor” and which is related to U.S. Provisional Application No. 62/763,166, filed Jun. 5, 2018, entitled “Disinfecting Opportunistic Premise Plumbing Pathogens Using Multiple Wavelength UV-LEDs” all in the names of the Hodon Ryu and Hyoungmin Woo and all of which are incorporated herein by reference in its entirety. The present patent application claims the benefit under 35 U.S.C § 119(e).

### TECHNICAL FIELD

The present application relates generally to the technical field of water filters, and more specifically, to the technical field of a filter assembly for a water use device for disinfecting pathogens from the water in the water use device using ultraviolet (UV) Light Emitting Diodes (LEDs) for UV disinfection of microbial pathogens.

### BACKGROUND

Water filters for attachment to a faucet, shower head or other plumbing fixtures have been around for many years. In general, these types of water filters may be inserted into a waterline prior to the water flowing to the plumbing fixture. The water filters take untreated water from a water line and discharges filtered water to the plumbing fixture.

Water filters that are inserted into the waterline prior to the plumbing fixture are generally designed to remove particulates from the water. These types of water filter may remove particles as small as 5 microns in size or smaller. However, these types of water filters generally have to be replaced on a routine basis. Further, these types of water filters are unable to remove chlorine or other oxidizing agents as well as different forms of bacteria and/or pathogens from the water.

There are water filters designed to remove chlorine or other oxidizing agents. Carbon filters have been designed for residential applications and may be used to remove chlorine from the water thereby improving water taste and odor. However, carbon filters have a relatively short life and by removing the chlorine or oxidizing agents, the treated water can become more susceptible to bacterial contamination. Further, carbon filters are unable to remove different forms of bacteria and/or pathogens from the water.

Further, present point-of-use (POU) filtration systems are unable to inactivate opportunistic premise plumbing pathogens (OPPPs) such as Legionella. Legionella bacteria can multiply in all kinds of water systems. The bacterium Legionella pneumophila is responsible for most cases of legionnaires' disease. Most people become infected when they inhale microscopic water droplets containing Legionella bacteria. This might be the spray from a shower, faucet or whirlpool, or water dispersed through the ventilation system.

Presently, to reduce the risk of Legionella bacteria growth in water systems, it is recommended that dead ends in pipe-work be removed, flush out infrequently used outlets, and clean and de-scale shower heads and hoses. However, presently there are no POU filtration devices that are capable of inactivating OPPPs such as Legionella.

Therefore, it would be desirable to provide a system and method that overcomes the above. The system and method would provide a POU filtration system that is able to inactivate OPPPs in hot water.

### SUMMARY

In accordance with one embodiment, a point-of-use (POU) filtration device is disclosed. The POU filtration device has a hollow conduit having open ends. An Ultraviolet Light Emitting Diode (UV-LED) module is coupled to the hollow container. The UV-LED module illuminates UV light into an interior of the hollow conduit, the UV light reflecting down the interior of the hollow conduit.

In accordance with one embodiment, a point-of-use (POU) filtration device is disclosed. The POU filtration device has a hollow conduit having open ends. The hollow conduit has an outer tube, an interior of the outer tube having UV reflective material and an inner tube formed of UV penetrable material. The inner tube slides within the outer tube forming the hollow conduit. An opening is formed through an exterior surface of the outer tube into the interior of the outer tube. An Ultraviolet Light Emitting Diode (UV-LED) module is coupled to the outer tube and positioned over the opening formed through the exterior surface of the outer tube. The UV-LED module illuminates UV light through the opening and into an interior of the outer tube. The UV reflective material allows the UV light to reflect down an entire length of the outer tube and penetrates the interior of the inner tube formed of UV penetrable material.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a bottom perspective view of an exemplary embodiment of a POU filtration device that is capable of inactivating OPPPs in accordance with one embodiment of the present invention;

FIG. 2 is a partial exploded view of an exemplary embodiment of the POU filtration device of FIG. 1 in accordance with one embodiment of the present invention;

FIG. 3 is an elevated perspective view of an exemplary embodiment of the filtering unit of the POU filtration device of FIG. 1 in accordance with one embodiment of the present invention;

FIG. 4 is a top view of an exemplary embodiment of the filtering unit of the POU filtration device of FIG. 1 in accordance with one embodiment of the present invention;

FIG. 5 is a top view of an exemplary embodiment of the filtering unit of the POU filtration device of FIG. 1 in accordance with one embodiment of the present invention;

FIG. 6 is a bottom perspective view of an exemplary embodiment of the POU filtration device of FIG. 1 in accordance with one embodiment of the present invention;

FIG. 7 is a side view of an exemplary embodiment of a POU filtration device that is capable of inactivating OPPPs in accordance with one embodiment of the present invention;

FIG. 8 is a cross-sectional view of the exemplary embodiment of a POU filtration device of FIG. 7 in accordance with one embodiment of the present invention;

FIG. 9A is a perspective view of the exemplary embodiment of a POU filtration device of FIG. 7 installed in a plumbing fixture in accordance with one embodiment of the present invention; and

FIG. 9B is a perspective view of the exemplary embodiment of a POU filtration device of FIG. 7 installed in a plumbing fixture in accordance with one embodiment of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a point-of-use (POU) filtration device that will inactivate opportunistic premise plumbing pathogens (OPPPs) such as Legionella. The system and method may utilize low power ultraviolet (UV) light emitting diodes (LEDs) positioned inside the POU filtration device. The low power UV LEDs may illuminate streams with multi-channel structures in order to inactivate OPPPs.

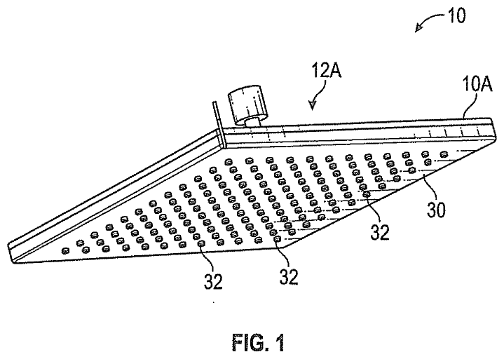

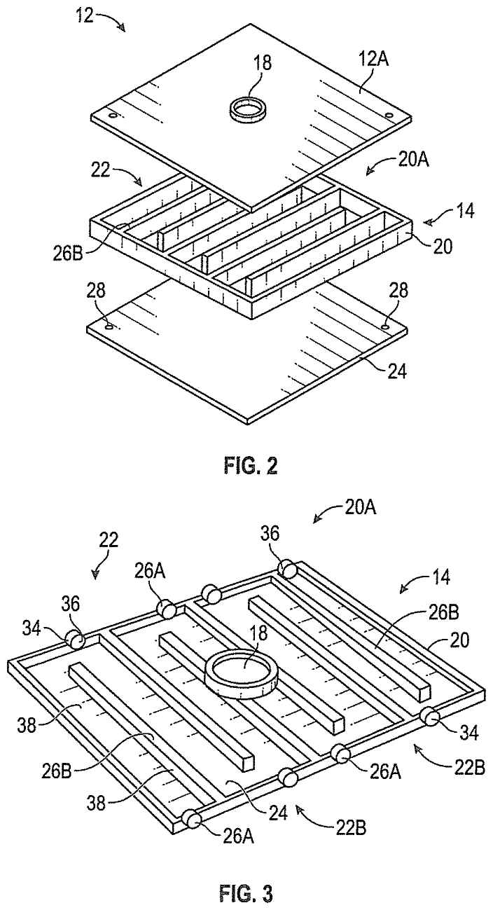

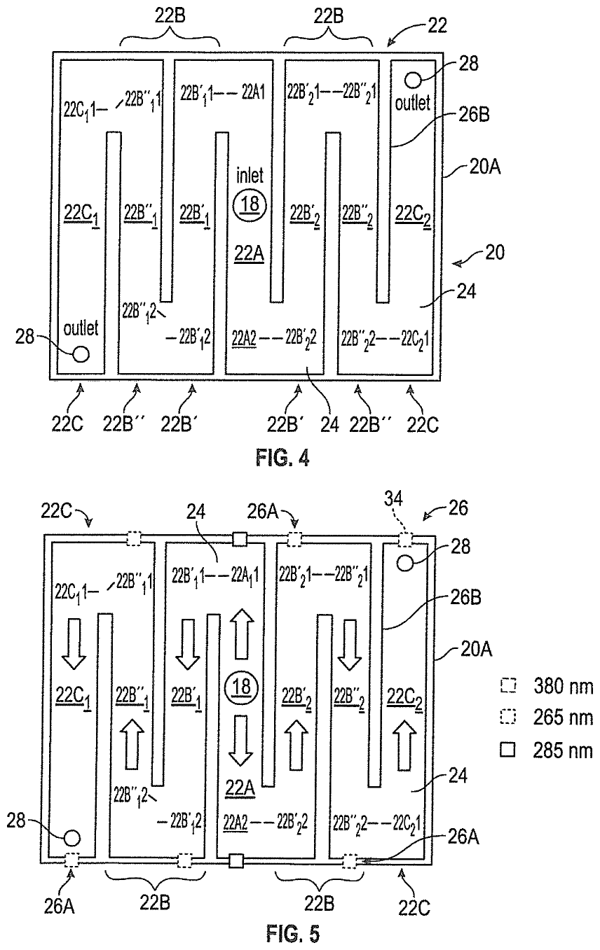

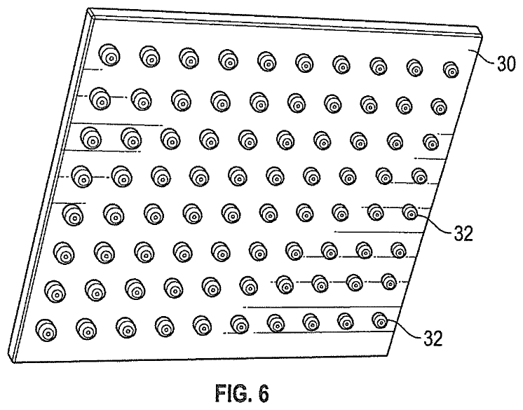

Referring to FIGS. 1-6, a point-of-use (POU) filtration device 10 may be seen. The POU filtration device 10 may be designed to inactivate opportunistic premise plumbing pathogens (OPPPs) such as Legionella. In the present embodiment, the POU filtration device 10 may be shown as a showerhead 10A. However, this is shown as one embodiment and should not be seen in a limiting manner. The POU filtration device 10 may be used with other plumbing fixtures without departing from the spirit and scope of the present invention.

The POU filtration device 10 may have a top cover 12, a filtering unit 14 and a bottom cover 16. The top cover 12 may be a planer member 12A. In the present embodiment, the top cover 12 may be square in shape. However, this is shown as one example and should not be seen in a limiting manner. The top cover 12 may be formed in other geometrical shapes based on the intended purpose or design. An opening 18 may be formed in a central area of the top cover 12. The opening 18 may be used to allow a waterline to be coupled to and supply the POU filtration device 10 with water.

The top cover 12 may be positioned on top of a filtering unit 14. The top cover 12 may be used to enclose the filtering unit 14 to prevent water from flowing out of a top area of the filtering unit 14. The filtering unit 14 may be formed of a container 20 having an open top surface 20A. The container 20 may be enclosed by coupling the top cover 12 over the open top surface 20A.

The filtering unit 14 may be designed to allow water entering through the opening 18 to flow through a plurality of channels 22 for water disinfection. The container 20 may have a plurality of channels 22 formed on a floor 24 of the container 20. The plurality of channels 22 may be formed by having a plurality of separation walls 26B attached to and extending up from the floor 24. In the present embodiment, the plurality of channels 22 run parallel to one another. Each channel 22 may be coupled to an adjacent channel 22 to allow water to flow through the filtering unit 14. In the present embodiment, each channel 22 may be coupled to an adjacent channel 22 to allow water to flow through the filtering unit 14 in a serpentine manner, i.e., up one channel 22 and down an adjacent channel 22 and/or vice versa.

In the present embodiment, the container 20 may have a center channel 22A. The center channel 22A may have an open end 22A1 and an open end 22A2, The open end 22A1 and the open end 22A2 may be formed on opposing ends of the center channel 22A and opposing sides. In the present embodiment, open end 22A1 may be formed on the upper end of the middle channel 22A and the open end 22A2 may be formed on the opposing end, the lower end of the center channel 22A. The open end 22A1 may be formed on a left side of the center channel 22A while open end 22A2 may be formed on the opposing side, the right side of the center channel 22A. However, this is shown as one embodiment and should not be seen in a limiting manner.

The filtering unit 14 may have one or more pair of side channels 22B. If pairs of side channels 22B are used, one side channel of each pair of side channels 22B may be positioned on each side (left side and right side) of the center channel 22A.

For example, in the present embodiment, a first pair of side channel 22B′ may be provided. The first pair of side channel 22B′ may be formed of side channels 22B′₁ and 22B′₂. Side channel 22B′₁ may be formed on the left side of and in fluid communication with the center channel 22A and the side channel 22B′₂ may be formed on the right side and in fluid communication with the center channel 22A.

Side channel 22B′₁ may have an open end 22B′₁1 and an open end 22B′₁2. The open end 22B′₁1 and the open end 22B′₁2 may be formed on opposing ends and opposing sides of the side channel 22B′₁. In the present embodiment, open end 22B′₁1 may be formed on the upper end of the side channel 22B′₁ and the open end 22B′₁2 may be formed on the opposing end, the lower end of the side channel 22B′₁. The open end 22B′₁1 may be formed on a right side of the side channel 22B′₁ and in fluid communication with the open end 22A1 of the center channel 22A. The open end 22B′₁2 of the side channel 22B′₁ may be formed on the opposing side, the left side of the side channel 22B′₁.

Side channel 22B′₂ may have an open end 22B′₂1 and an open end 22B′₂2. The open end 22B′₂1 and the open end 22B′₂2 may be formed on opposing ends and opposing sides of the side channel 22B′₂. In the present embodiment, open end 22B′₂1 may be formed on the upper end of the side channel 22B′₂ and the open end 22B′₂2 may be formed on the opposing end, the lower end of the side channel 22B′₂. The open end 22B′₂1 may be formed on a right side of the side channel 22B′₂. The open end 22B′₂2 of the side channel 22B′₂ may be formed on the opposing side, the left side of the side channel 22B′₂ and in fluid communication with the open end 22A2 of the center channel 22A.

In the present embodiment, the filtering unit 14 may have a second pair of side channel 22B″. The second pair of side channel 22B″ may be formed of side channels 22B″₁ and 22B″₂. Side channel 22B″₁ may be formed on the left side of the center channel 22A and in fluid communication with the side channel 22B′₁ of the first pair of side channels 22B′ and the side channel 22B″₂ may be formed on the right side of the center channel 22A and in fluid communication with the side channel 22B′₂.

Side channel 22B″₁ may have an open end 22B″₁1 and an open end 22B″₁2. The open end 22B″₁1 and the open end 22B″₁2 may be formed on opposing ends and opposing sides of the side channel 22B″₁. In the present embodiment, open end 22B″₁1 may be formed on the upper end of the side channel 22B″₁ and the open end 22B″₁2 may be formed on the opposing end, the lower end of the side channel 22B′″₁. The open end 22B″₁1 may be formed on a left side of the side channel 22B″₁. The open end 22B″₁2 of the side channel 22B″₁ may be formed on the opposing side, the right side of the side channel 22B″₁ and in fluid communication with the open end 22B′₁2 of the side channel 22B′₁.

Side channel 22B″₂ may have an open end 22B″₂1 and an open end 228″₂2. The open end 22B″₂1 and the open end 22B″₂2 may be formed on opposing ends and opposing sides of the side channel 22B″₂. In the present embodiment, open end 22B″₂1 may be formed on the upper end of the side channel 228″₂ and the open end 22B″₂2 may be formed on the opposing end, the lower end of the side channel 22B″₂. The open end 228″21 may be formed on a left side of the side channel 22B″₂ and in fluid communication with the open end 22B′₂1 of the side channel 22B′₂. The open end 22B″₂2 of the side channel 22B″₂ may be formed on the opposing side, the right side of the side channel 228″₂.

In the present embodiment, the filtering unit 14 may have a pair of end channels 22C. The pair of end channels 22C may be formed of end channel 22C₁ and 22C₂. End channel 22C₁ may be formed on the left side of the center channel 22A and in fluid communication with the side channel 22B″₁ of the second pair of side channels 22B₁ and the end channel 22C₂ may be formed on the right side of the center channel 22A and in fluid communication with the side channel 22B″₂.

End channel 22C₁ may have an open end 22C₁1. In the present embodiment, open end 22C₁1 may be formed on the upper end of the end channel 22C₁. The open end 22C₁1 may be formed on a right side of the end channel 22C₁ and in fluid communication with the open end 22B″₁1 of the side channel 22B″₁.

End channel 22C₂ may have an open end 22C₂1. In the present embodiment, open end 22C₂1 may be formed on the lower end of the end channel 22C₂. The open end 22C₂1 may be formed on a left side of the end channel 22C₂ and in fluid communication with the open end 22B″₂2 of the side channel 22B″₂.

Located in each of the plurality of channels 22 is one or more Ultraviolet (UV) lights 26. The UV lights 26 may be used for UV disinfection of water flowing through the channels 22. In accordance with one embodiment, UV Light Emitting Diodes (LEDs) 26A may be used. The UV LEDs 26A will allow for lower power consumption than conventional mercury vapor lamps as well as to allow for a more compact design of the POU filtration device 10.

One or more UV LEDs 26A may be placed in each of the plurality of channels 22. In the present embodiment, the UV LEDs 26A may be placed either in an upper and/or lower end of each of the plurality of channels 22.

The UV LEDs 26A may be placed in a side wall 20A of the container 20. The side walls 20A may define an exterior perimeter of the container. The side walls 20A may provide a pathway for wiring for powering the UV LEDs 26A. Waterproof seals 34 may be used to prevent water from leaking into the side walls 20A.

Further, by placing the UV LEDs 26A either in an upper and/or lower section of each of the plurality of channels 22 and in the side wall 20A of the container 20, the UV LEDs 26A may emanate UV light down and through each of the plurality of channels 22 disinfecting the water as the water flows through the associated channel 22. A lens 36 or similar optical element may be attached to one or more to the UV LEDs 26A. The lens 36 may be used to focus and direct the UV light emanating from the UV LED 26A down and through each of the associated channel 22.

In the present embodiment, the UV LEDs 26A may be positioned at an end of each channel 22 where water may exit the associated channel 22. Thus, UV LEDs 26A may be placed at each end of the center channel 22A. The UV LEDs 26A may be located proximate each open end 22A₁ and 22A₂ of the center channel 22A. For side channel 22B′₁, the UV LEDs 26A may be placed proximate the open end 22B′₁2. For side channel 22B′₂, the UV LEDs 26A may be placed proximate the open end 22B′₂1. For side channel 22B″₁, the UV LEDs 26A may be placed proximate the open end 22B″₁1. For side channel 22B″₂, the UV LEDs 26A may be placed proximate the open end 22B″₂2. For the end channels 22C€ and 22C2, the UV LEDs 26A may be positioned near where water may exit the filtering unit 14. Thus, for the end channel 22C₁, the UV LED 26A may be positioned near a lower end of the end channel 22C₁. For the end channel 22C₂, the UV LEDs 26A may be positioned near an upper end of the end channel 22C₂.

To improve the efficacy of UV disinfection, the UV LEDs 26A may emit UV light in different frequencies. For example, different UV LEDs 26A may emit UV light in the UVA, UVB and/or UVC ranges. In accordance with the one embodiment, different UV LEDs 26A may emit UV light at 265 nm, 285 nm, and 380 nm. Thus, for example, the UV LEDs 26A in the center channel 22A may emit UV light at 285 nm, the UV LEDs 26A in the pairs of side channels 22B may emit UV light at 380 nm and the UV LEDs 26A in the pair of end channels 22C may emit UV light at 265 nm.

UV light in the 265 nm wavelength may be used as this wavelength is near the relative peak absorption of nucleic acids to target genomes of OPPPs. UV light in the 285 um wavelength may be used as this wavelength is near the relative peak absorption of proteins to target protein-based regions of OPPPs. UV light in the 380 nm wavelength may be used to enhance advanced oxidation with photo-catalyst along with other UV LEDs as will be described below.

To improve the efficacy of UV disinfection, the top cover 12, the floor 24 and/or the separation walls 26B may be coated with photo reactant and/or UV reflective materials 38. In accordance with one embodiment, the top cover 12, the floor 24 and/or the separation walls 26B may be coated with a photo reactant material such as Titanium dioxide (TiO₂) and/or UV reflective materials such as aluminum foil and polytetrafluoroethylene (PTFE). The UV light from the UV LEDs 26A may cause a photocatalyst reaction which may generate oxidative species or hydroxyl radicals to inactivate pathogens. Thus, as described above, UV light in the 380 nm wavelength as well as the other wavelengths maybe used to enhance advanced oxidation with the photo-catalyst. The use of UV reflective materials may increase total UV irradiance exposure to flowing water and consequently enhance the inactivation efficacy of OPPPs in water.

The filtering unit 14 may have one or more drainage openings 28. The drainage openings 28 may be formed in the floor 24 of each end channel 22C₁ and 22C₂. The drainage openings 28 may allow water flowing through each end channel 22C₁ and 22C₂ to exit the filtering unit 14. In accordance with the present embodiment, the drainage openings 28 may be positioned in the end of each end channel 22C₁ and 22C₂ furthest from the open end 22C₁1 and open end 22C₂1 respectively.

As may be seen by the arrows in FIG. 5, water may enter the POU filtration device 10 through the opening 18 formed in the top cover 12. The opening 12 may be located above and in a middle area of the center channel 22A. The water entering the center channel 22A may flow out towards the open end 22A₁ and the open end 22A₂ where it may enter the first pair of side channel 22B′. The water may flow either into side channel 22B′₁ or side channel 22B′₂ via the open end 22B′₁1 or 22B′₂2 respectively. The water may flow through the side channel 22B′₁ towards the open end 22B′₁2 and into the side channel 22B″₁ via the open end 22B″₁ 2. Similarly, water may flow through the side channel 22B′₂ towards the open end 22B′₂1 and into the side channel 22B″₂ via the open end 22B″₂1. The water flowing through the side channel 22B″₁ may flow out of the open end 22B″₁1 and into the end channel 22C₁ via opening 22011. Similarly, the water flowing through the side channel 22B″₂ may flow out of the open end 22B″₂2 and into the end channel 22C₂ via opening 22C₂1. Water flowing through the end channels 22C₁ and 22C₂ may then exit the filtering unit 14 via the drainage opening 28 located at the end of each end channel 22C. Once the water exits the filtering unit 14, the water will drain to a collection plate 30. The collection plate 30 may have one or more openings 32 to allow the water to exit the POU filtration device 10. In the present embodiment, the collection plate 30 may have a plurality of openings 32 formed in an array as the POU filtration device 10 may be used as a shower head. However, this is just one example as the POU filtration device 10 may be used with other plumbing fixtures.

The plurality of channels 22 may be configured to allow the UV LEDs 26A time to disinfect the water flowing therethrough. The dimension of the channels 22 may be based on the plumbing fixture the POU filtration device 10 is used with.

If the germicidal UV irradiation fluence energy reaches at above I mJ/cm² with effective UV dose and exposure duration, Legionella will be inactivated at 2-log scale (equivalent to 99% removal rate). The UV dose may be measured using a calibrated radiometer in units of millijoules per square centimeter (mJ/cm²) delivered by the UV disinfection device to the required level.

As an example, in one embodiment, the POU filtration device 10 may be used as a rain shower head. If the POU filtration device 10 has a configuration similar to that shown in FIGS. 1-6, the filtering unit 14 may be configured as having six separations walls 26B forming seven channels 22. For calculation purposes, each channel 22 may be 1 inch wide, 10 inches long, and ¼ inch in depth. The separation walls 26B may each be ½ inch in width. The water entering the opening 18 may be divided into two streams flowing in the opposite direction.

If a typical water shower uses 2.5 gallons per minute (gpm), then 1.25 gpm of water may flow in each direction through the channels 22. Thus, it takes about 2 seconds for water entering the opening 18 to flow out of one of the drainage openings 28. Each UV LED 26A may have at least 0.5 mW/cm² irradiance intensity to get 1 mJ/cm². For a typical shower head that supplies average flow rate at 2.5 gpm, the estimated water residence time is 1.82 sec (1.25 gpm=3.785*1.25=4.731 lpm, A=¼″*1″=0.25 inch 2=1.613 cm², V=Q/A=4.731 lpm/60 sec/min/1.613 cm²*1000 cm³/liter=48.884 cm/sec, flow path length for one channel=35″=88.9 cm, residence time=flow path/velocity=88.9 cm/48.884 cm/sec=1.82 sec).

For a reduced flow shower head that uses 30% less flow and supplies water with average flow rate at 2 gpm, the estimated water residence time is 2.27 sec (1 gpm=3.785 lpm, A=¼″*1″=0.25 inch 2=1.613 cm². V=Q/A=3.785 lpm/60 sec/min/1.613 cm²*1000 cm³/liter=39.109 cm/sec, flow path length for one channel=35″=88.9 cm, residence time=flow path/velocity=88.9 cm/39.109 cm/sec=2.27 sec).

The present invention provides a POU filtration device 10 that may inactivate OPPPs such as Legionella. The POU filtration device 10 may use low power UV LEDs 26A. The UV LEDs 26A may be positioned in a multi-channel structure in the POU filtration device 10. The UV light emitted by the UV LEDs 26A may inactivate OPPPs as water flows through the multi-channel structure in the POU filtration device 10. To improve the efficacy of UV disinfection, the UV LEDs 26A may emit UV light in different frequencies. For example, different UV LEDs 26A may emit UV light in the UVA, UVB and/or UVC ranges. The POU filtration device 10 may use a photo reactant and/or UV reflective material. The UV light from the UV LEDs 26A may cause a photocatalyst reaction which may generate oxidative species or hydroxyl radicals to inactivate microbial pathogens. Moreover, the use of UV reflective materials may increase total UV irradiance exposure to flowing water and consequently enhance the inactivation efficacy of OPPPs in water.

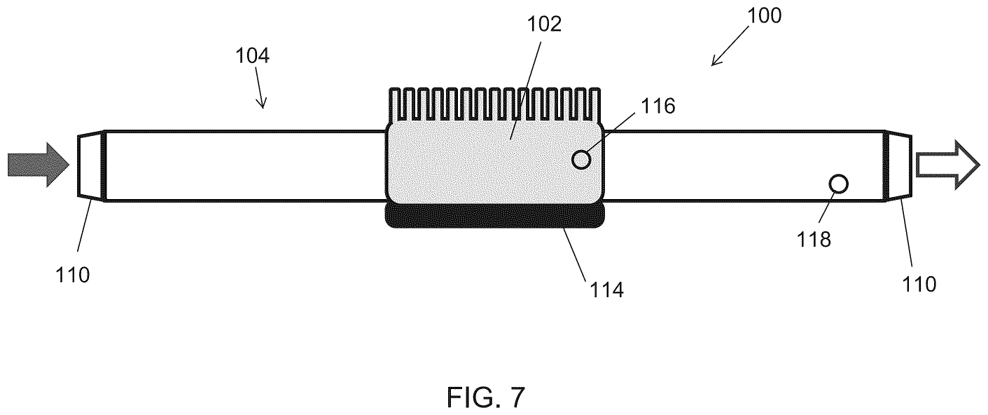

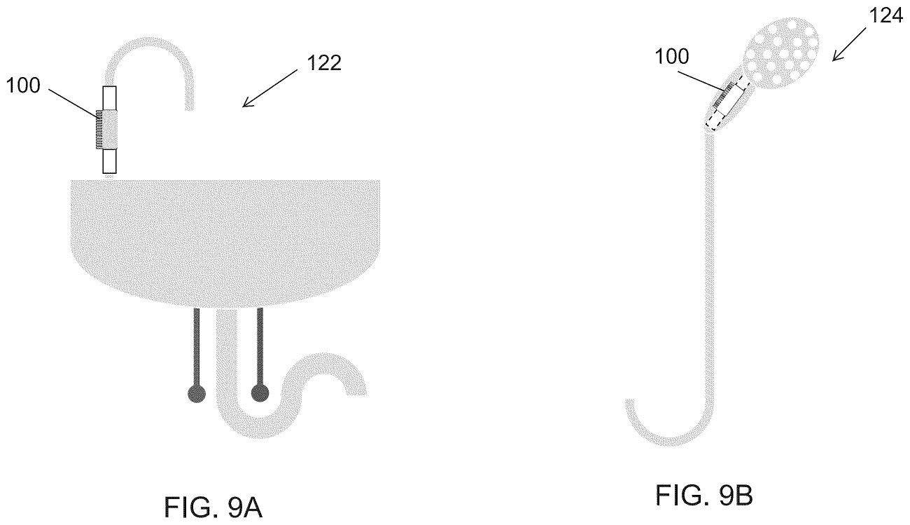

Referring to FIGS. 7-9B, a point-of-use (POU) filtration device 100 may be seen. The POU filtration device 100 may be designed to inactivate opportunistic premise plumbing pathogens (OPPPs) such as Legionella and other microorganisms such as waterborne and airborne pathogens. The POU filtration device 100 may be placed within any type of plumbing fixture such as a waterline to a sink/faucet 122 as may be seen in FIG. 9A, a waterline to a showerhead 124 as may be seen in FIG. 9B, or any other type of plumbing/water use fixture. The listing of the above is given as an example and should not be seen in a limiting manner. The POU filtration device 100 may be used with other plumbing and or water use fixtures. For example, the POU filtration device 100 may be used on home appliances such as air conditioners, air purifiers, humidifiers, and the like. Again, these are just examples and is not an exclusive listing.

In the embodiment shown, the POU filtration device 100 may have tubular configuration having one or more UV-LED modules 102. While only one UV-LED module 102 may be shown, the POU filtration device 100 may have multiple UV-LED modules 102 depending on the length of the POU filtration device 100. Further, while the present embodiment shows a tubular configuration for the POU filtration device 100, this may be shown only as an example. The POU filtration device 100 may take on other geometrical configurations without departing from the spirit and scope of the present invention.

The POU filtration device 100 may be formed of a conduit 104. The conduit 104 may have open ends and may be hollow which may allow water to flow through the conduit 104. The size of the conduit 104 may vary. In accordance with one embodiment, the size of the conduit 104 may be based on the plumbing and or water use fixture using the POU filtration device 100 as well as the size of the water line serving the plumbing and or water use fixture.

In accordance with one embodiment, the conduit 104 may be formed of an outer tube 106 and an inner tube 108. An outer diameter of the inner tube 108 may be smaller than an inner diameter of the outer tube 106. This may allow for the inner tube 108 to slide within the outer tube 106. In accordance with one embodiment, an inner surface 106A of the outer tube 106 may be adjacent and parallel to an exterior surface 108A of the inner tube 108.

The inner surface 106A of the outer tube 106 may be formed and/or coated with a reflective material 110. The reflective material 110 may be able to provide reflectivity of UV radiation as may be disclosed below. In accordance with one embodiment, the reflective material 110 may be polytetrafluoroethylene (PTFE), aluminum, or other UV reflective materials.

The inner tube 108 may be formed of a UV penetrable material. For example, the inner tube 108 may be formed of a UV penetrable fused silica or quartz. Inserting the inner tube 108 within the outer tube 106 allows the conduit 104 to form a two-layer structure having UV reflective material 110 on the inner surface 106A of the outer tube 106 while avoiding direct contact with water flowing through the inner tube 108. This may prevent harmful, toxic leachates of UV reflective material 110 from the outer tube 106 to the water. Further, the material used for the inner tube 108 may have benefit of suppressing line-fouling biofilm accumulation.

The UV-LED module 102 may be used for UV disinfection of water flowing through the conduit 104. While only one UV-LED module 102 may be shown, multiple UV-LED modules 102 may be connected together if the POU filtration device 100 uses a longer conduit 104.

The UV-LED module 102 may be formed of a UV-LED lighting unit 112. The UV-LED lighting unit 112 may emit UV light. To improve the efficacy of UV disinfection against a variety of microbial pathogens such as bacteria, viruses and protozoan parasites, the UV-LED lighting unit 112 may emit UV light in different frequencies. In accordance with one embodiment, the UV-LED lighting unit 112 may emit UV light within the UVC (200-280 nm) range.

A power supply 114 may be coupled to the UV-LED module 102. The power supply 114 may be used to power components of the UV-LED module 102 and other components of the POU filtration device 100. In accordance with one embodiment, the power supply 114 may be a rechargeable battery. However, this is only one example. Other power supplies may be used without departing from the spirit and scope of the present invention.

The POU filtration device 100 may have a status indicator 116. The status indicator 116 may be coupled to the UV-LED module 102. The status indicator 116 may be used to indicate if the UV-LED module 102 is active (i.e., UV-LED lighting unit 112 active) or not. If the UV-LED module 102 is active, the status indicator 116 may illuminate or provide another visual and/or audible indication that the UV-LED module 102 is active. Otherwise, the status indicator 116 may remain off and not provide another visual and/or audible indication. In accordance with one embodiment, the status indicator 116 may be an LED light or the like.

The POU filtration device 100 may have a water flow sensor 118. The water flow sensor 118 may be coupled to the UV-LED module 102. The water flow sensor 118 may provide data about water flowing through the conduit 104. In accordance with one embodiment, the water flow sensor 118 may be placed inside the inner tube 108 and provides data to the UV-LED module 102 about water flowing through the inner tube 108. In accordance with one embodiment, the UV-LED module 102 may turn on as soon as the water flow sensor 118 determines that water is flowing inside the inner tube 108. When the water flow sensor 118 senses that water flow has stopped, a signal may be sent to turn the UV-LED module 102 off. By having the UV-LED module 102 only on when water is flowing, energy may be saved as the UV-LED module 102 may be off when there is no water flow.

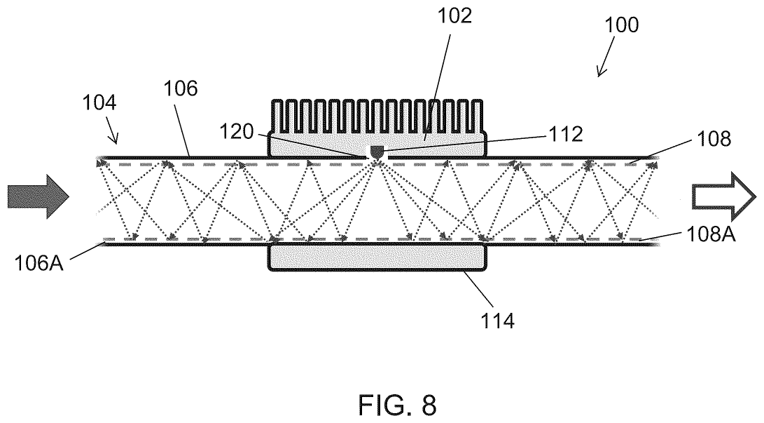

The outer tube 106 may have one or more openings 120. The opening 120 may be formed on a top exterior surface of the outer tube 106. The number of openings 120 may correspond to the number of UV-LED modules 102 being attached to the outer tube 106. When attaching the UV-LED modules 102 to the outer tube 106, the UV-LED lighting unit 112 may be positioned to allow the UV light to enter the interior of the conduit 104. Since the inner surface 106A of the outer tube 106 may be formed and/or coated with a reflective material 110 and the inner tube 108 may be formed of a UV penetrable material, the UV light may travel down the interior of the conduit 104 as may be shown in FIG. 8. Water flowing through the inner tube 108 may be exposed to the UV irradiance from the UV light enhancing the inactivation efficacy of microbial pathogens in water or air within the interior of the conduit 102.

Use of reflective material 110 with use of different wavelengths of UV light increases the microbial inactivation efficacy in water or air. Smoother surfaces of the inner tube 108 and extended UV exposure distance by three dimensional UV reflection may enhance mitigation of biofilm formation on the surface of the inner tube 108 where water contacts.

To secure the POU filtration device 100 in a water line of a plumbing fixture of water use device, a connector 110 may be attached to each end of the conduit 104. In accordance with one embodiment, the connectors 110 may be water tight fittings which secure each end of the conduit 104 to the water line thereby preventing any water leakage to and from the POU filtration device 100.

The foregoing description is illustrative of particular embodiments of the application but is not meant to be a limitation upon the practice thereof. The following claims, including all equivalents thereof, are intended to define the scope of the application.

What is claimed is:

1. A Point of Use (POU) filtration device comprising:
a hollow conduit having open ends;
an Ultraviolet Light Emitting Diode (UV-LED) module coupled to the hollow container, the UV-LED module illuminating UV light into an interior of the hollow conduit, the UV light reflecting down the interior of the hollow conduit.

2. The POU filtration device of claim 1, wherein the hollow conduit comprises:
an outer tube, wherein an interior of the outer tube has UV reflective material; and
an inner tube formed of UV penetrable material, wherein the inner tube slides within the outer tube.

3. The POU filtration device of claim 2, wherein the UV reflective material is one of polytetrafluoroethylene (PTFE) or aluminum.

4. The POU filtration device of claim 2, wherein the UV penetrable material is one of fused silica or quartz.

5. The POU filtration device of claim 1, wherein the UV-LED module comprises:
a UV-LED lighting unit, wherein the UV-LED lighting unit is positioned over an opening in a top surface of the hollow conduit, the UV-LED lighting unit illuminating UV light into an interior of the hollow conduit, the UV light reflecting down the interior of the hollow conduit; and
a power supply coupled to the UV-LED lighting unit.

6. The POU filtration device of claim 5, wherein the UV-LED module comprises a status indicator indicating whether the UV-LED module has been activated or deactivated.

7. The POU filtration device of claim 5, wherein the UV-LED module comprises a water flow sensor, the water flow sensor status indicator indicating water flow through the POU filtration device.

8. The POU filtration device of claim 5, wherein the UV-LED module comprises a water flow sensor, the water flow sensor status indicator indicating water flow through the POU filtration device, wherein the water flow sensor activates the UV-LED lighting unit when the water flow is detected and deactivates the UV-LED lighting unit when water flow is not detected.

9. The POU filtration device of claim 1, wherein the UV-LED module emits UV light in different frequencies.

10. The POU filtration device of claim 5, wherein the UV-LED module emits UV light within the UVC (200-280 nm) range.

11. A Point of Use (POU) filtration device comprising:
a hollow conduit having open ends, wherein the hollow conduit comprises:
an outer tube, an interior of the outer tube having UV reflective material; and
an inner tube formed of UV penetrable material, wherein the inner tube slides within the outer tube;
an opening formed through an exterior surface of the outer tube into the interior of the outer tube;
an Ultraviolet Light Emitting Diode (UV-LED) module coupled to the outer tube and positioned over the opening formed through the exterior surface of the outer tube, the UV-LED module illuminating UV light through the opening and into an interior of the outer tube, the UV reflective material allowing the UV light to reflect down an entire length of the outer tube and penetrating the interior of the inner tube formed of UV penetrable material.

12. The POU filtration device of claim 11, wherein the UV reflective material is one of polytetrafluoroethylene (PTFE) or aluminum.

13. The POU filtration device of claim 11, wherein the UV penetrable material is one of fused silica or quartz.

14. The POU filtration device of claim 11, wherein the UV-LED module comprises:
a UV-LED lighting unit, wherein the UV-LED lighting unit is positioned over the opening formed through the exterior surface of the outer tube into the interior of the outer tube, the UV-LED lighting unit illuminating UV light into the interior of the outer tube, the UV light reflecting down an entire length of the interior of the ube ad through the

15. The POU filtration device of claim 14, wherein the UV-LED module comprises a power supply coupled to the UV-LED lighting unit.

16. The POU filtration device of claim 15, wherein the UV-LED module comprises a status indicator indicating whether the UV-LED module has been activated or deactivated.

17. The POU filtration device of claim 15, wherein the UV-LED module comprises a water flow sensor, the water flow sensor status indicator indicating water flow through the POU filtration device.

18. The POU filtration device of claim 15, wherein the UV-LED module comprises a water flow sensor, the water flow sensor status indicator indicating water flow through the POU filtration device, wherein the water flow sensor activates the UV-LED lighting unit when the water flow is detected and deactivates the UV-LED lighting unit when water flow is not detected.

159. The POU filtration device of claim 15, wherein the UV-LED module emits UV light in different frequencies.

20. The POU filtration device of claim 15, wherein the UV-LED module emits UV light within the UVC (200-280 nm) range.
